(19) United States
(12) Patent Application Publication
(10) Pub. No.: US 2026/0145978 A1
(43) Pub. Date: May 28, 2026

(54) BATCH FEEDSTOCK DELIVERY

(71) Applicant: Owens-Brockway Glass Container Inc., Perrysburg, OH (US)

(72) Inventors: Zhongming Wang, Ypsilanti, MI (US); Scott Weil, Perrysburg, OH (US); Liming Shi, Perrysburg, OH (US)

(21) Appl. No.: 18/959,994

(22) Filed: Nov. 26, 2024

(51) Int. Cl. C03B 3/00; C03B 5/235

(52) U.S. Cl. CPC C03B 3/00; C03B 5/2356; C03B 2211/20

(57) ABSTRACT

A batch feedstock delivery system, a glass manufacturing system that includes the batch feedstock delivery system, and a method of delivering a segregated batch feedstock to a submerged combustion melter and producing molten glass are disclosed. The batch feedstock delivery system includes a plurality of raw material containers and a batch conveyor, but does not include a batch mixer, and the segregated batch feedstock is produced at the batch feedstock delivery system. The segregated batch feedstock includes identifiably distinctive portions of sand, soda ash, and limestone and may optionally also include cullet. The segregated batch feedstock that is prepared at the batch feedstock delivery system is conveyed towards the submerged combustion melter, introduced into the submerged combustion melter, and melted in the submerged combustion melter to produce molten glass.

### TECHNICAL FIELD

This patent application discloses innovations in glass manufacturing systems and, more particularly, in the delivery of a batch feedstock to a submerged combustion melter.

### BACKGROUND

The manufacture of glass articles, such as glass containers, requires a vitrifiable batch feedstock to be delivered to a glass melting apparatus so that the feedstock can be melted into molten glass. The batch feedstock material includes raw materials such as sand, soda ash, and limestone, plus other minor raw materials, and may also include recycled glass (or “cullet”). Typically, in a glass manufacturing plant that includes a conventional glass melting furnace, the various materials included in the batch feedstock are stored in a conventional batch house. A conventional batch house is usually several stories tall and includes a raw material unloading platform, large multi-story silos that separately store sand, soda ash, and limestone, and ground-level cullet pads where cullet is dumped and maintained until needed. The silos are serviced by bucket elevators and input conveyors that operate to move their respective raw materials from an underground unloading pit where the raw materials are initially unloaded to the tops of the silos where the raw materials are introduced into the silos for storage.

The conventional batch house additionally includes at least one batch mixer that receives the individual raw materials from their respective silos and a system of feeders, weigh scales, and output conveyors that deliver the correct quantities of the raw materials to the mixer. Any minor raw materials that need to be included in the batch feedstock are also delivered to the mixer at the correct quantities from smaller tanks or bins located elsewhere within the batch house. The mixer mixes the various raw materials together and provides the batch feedstock to an associated mixer conveyor that delivers the batch feedstock out of the batch house for melting in the furnace. If cullet is added to the batch feedstock, the cullet, which may be crushed on-site and delivered to a cullet silo, is added into the batch mixer with the raw materials or is added to the batch feedstock on the mixer conveyor. The raw materials included in the batch feedstock are generally well mixed together to help ensure an efficient melting process in the furnace. This is especially true since the batch feedstock is introduced as into the furnace as a batch blanket on top of a large and relatively calm molten glass bath. If the batch feedstock is not thoroughly mixed, portions of the feedstock may not melt into molten glass as intended, which can cause unwanted stones, for example, to persist within the glass bath.

The conventional approach to raw material delivery has worked well in the past for large continuous melting furnaces. However, a different approach to glass melting that utilizes a submerged combustion melter to melt the glass feedstock, instead of a continuous melting furnace, has brought renewed attention to the way in which the batch feedstock is delivered for melting. Most notably, in a submerged combustion melter, a plurality of submerged burners heat and agitate a glass melt by firing combustion products directly into the glass melt. The direct firing of combustion products into the glass melt enhances the rate of heat and mass transfer between the batch feedstock and the glass melt compared to the slower reaction kinetics of a continuous glass melting furnace and, as such, the residence time of glass within a submerged combustion melter is much shorter. To that end, when producing molten glass in a submerged combustion melter, the batch feedstock may not have to be thoroughly and arbitrarily mixed together before being introduced into the melter, which may allow for some added flexibility in the design of the feedstock delivery infrastructure and/or the way in which the batch feedstock is prepared and delivered to the submerged combustion melter.

### SUMMARY OF THE DISCLOSURE

A batch feedstock delivery system, a glass manufacturing system that includes the batch feedstock delivery system, and a method of delivering a segregated batch feedstock to a submerged combustion melter are disclosed. The batch feedstock delivery system includes a plurality of raw material containers and a batch conveyor, but does not include a batch mixer operationally between the raw material containers and the batch conveyor. The plurality of raw material containers includes at least (i) a first raw material container, (ii) a second raw material container, and (iii) a third raw material container that, respectively, contain and store the following raw materials: sand, soda ash, and limestone. The batch feedstock delivery system may additionally include a cullet container that contains and stores cullet. Each of the raw material containers is arranged to discharge its contained raw material onto the batch conveyor to produce the segregated batch feedstock. The cullet container, if present, may or may not be arranged to discharge cullet onto the batch conveyor. The batch conveyor conveys the batch feedstock downstream of, and away from, the plurality of raw material containers. In a glass manufacturing system that includes the batch feedstock delivery system, the segregated batch feedstock, which may or may not include cullet, is delivered from the batch feedstock delivery system and is introduced into a submerged combustion melter.

The segregated batch feedstock produced by the batch feedstock delivery system and conveyed along the batch conveyor is considered “segregated” since the batch feedstock delivery system does not include a batch mixer operationally between the plurality of raw material containers and the batch conveyor. The segregated batch feedstock includes identifiably distinctive portions of sand, soda ash, and limestone that, respectively, contain at least 90 wt % of sand, at least 90 wt % of soda ash, and at least 90 wt % of limestone. Such segregation of the raw materials is in contract to the raw materials being thoroughly and arbitrarily mixed together as would be the case if the raw materials are received and mixed in a batch mixer. The segregated batch feedstock may comprise, for example, distinctive overlying layers of sand, soda ash, and limestone, distinctive laterally adjacent layers of sand, soda ash, and limestone, and/or distinctive piles of sand, soda ash, and limestone. If cullet is included in the segregated batch feedstock, the cullet is preferably disposed over the identifiably distinct portions of sand, soda ash, and limestone as a top layer that covers the identifiably distinct portions of sand, soda ash, and limestone. The cullet, in that regard, is also an identifiably distinct portion of cullet that comprises at least 90 wt % of cullet.

The segregated batch feedstock is conveyed on batch conveyor and may be introduced into the submerged combustion melter in any of a variety of ways. As one example, the segregated batch feedstock is delivered to a batch charger, which in turn introduces the feedstock into the submerged combustion melter. The batch charger may be configured to introduce the segregated batch feedstock directly in a glass melt contained within the submerged combustion melter or the batch charger may be configured to introduce the segregated batch feedstock into a head space of the submerged combustion melter above the glass melt. In another example, the segregated batch feedstock, which does not contain cullet, is delivered to a glass charger that is configured to introduce the feedstock directly into a glass melt contained within the submerged combustion melter while, separately, a cullet feedstock is introduced into a head space of the submerged combustion melter above the glass melt. By keeping cullet out of the segregated batch feedstock and, instead, separately feeding cullet into the submerged combustion melter, the batch feedstock can be more easily analyzed prior to be being introduced into the melter, for example, among other possible opportunities.

### BRIEF DESCRIPTION OF THE DRAWINGS

FIG. 1 is an elevational schematic view of a batch feedstock delivery system, which is part of an overall glass manufacturing system, in accordance with an illustrative embodiment of the present disclosure;

FIG. 2 is a side schematic view of a layered configuration of a segregated batch feedstock, which may be produced by the batch feedstock delivery system of FIG. 1.

FIG. 3A is a top schematic view of a striped configuration for a segregated batch feedstock, which may be produced by the batch feedstock delivery system of FIG. 1 according to one embodiment of the present disclosure;

FIG. 3B is a top schematic view of a striped configuration for a segregated batch feedstock, which may be produced by the batch feedstock delivery system of FIG. 1 according to another embodiment of the present disclosure;

FIG. 4 is a top schematic view of a piled configuration for a batch feedstock, which may be produced by the batch feedstock delivery system of FIG. 1; and

FIG. 5 is an elevational schematic view of a batch feedstock delivery system, which is part of an overall glass manufacturing system, in accordance with another illustrative embodiment of the present disclosure.

### DETAILED DESCRIPTION

A batch feedstock delivery system includes a plurality of raw material containers and a batch conveyor and, specifically, does not include a batch mixer that thoroughly and arbitrarily mixes together the raw materials discharged from the plurality of raw material containers. In this way, a segregated batch feedstock is produced at the batch feedstock delivery system and is ultimately delivered from the feedstock delivery system and introduced into a submerged combustion melter. The segregated batch feedstock is melted within the submerged combustion melter to produce molten glass that may subsequently be formed into glass containers after being discharged from the melter. The batch feedstock delivery system may be retrofit into and installed within a conventional batch house or it may be housed within a structure specifically designed to accommodate the system. Because the batch feedstock delivery system does not include a batch mixer, the delivery system, compared to a conventional batch house, may have greater flexibility in its deployment to support the overall glass manufacturing system and can avoid the capital costs, maintenance, on-going operation, and general support associated with a batch mixer.

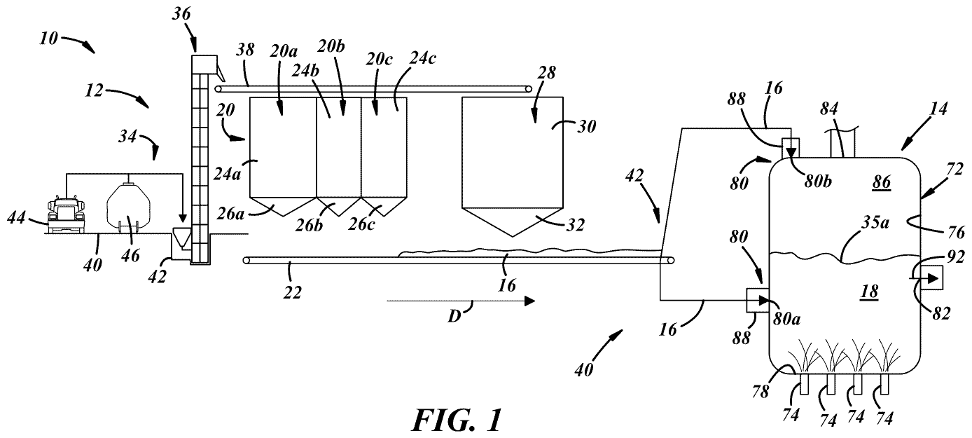

FIG. 1 illustrates a portion of a glass manufacturing system 10 according to one embodiment for producing glass articles such as, for example, glass containers. The glass manufacturing system 10 includes a batch feedstock delivery system 12 and a submerged combustion melter 14 downstream from the delivery system 12. A segregated batch feedstock 16 is produced at, and delivered from, the batch feedstock delivery system 12 and is then introduced into the submerged combustion melter 14. The segregated batch feedstock 16 is supplied to a glass melt 18 contained within the submerged combustion melter 14 and is melted within the glass melt 18 to produce molten glass. The glass melt 16 and, thus, the molten glass produced from the segregated batch feedstock 16, is preferably soda-lime-silica glass, which has a glass chemical composition that includes 60-80 wt % (more narrowly 70-75 wt %) SiO₂, 8 -18 wt % (more narrowly 11-16 wt %) Na₂O, and 5-15 wt % (more narrowly 8-13 wt %) CaO. The glass chemical composition of soda-lime-silica glass may include other additional components including, for example, 0-3 wt % (more narrowly 0.5-2.5 wt %) Al₂O₃ as well as other common constituents often found in glass. And, while not explicitly shown here in FIG. 1, the glass manufacturing system 10 may include fining, conditioning, and forming equipment downstream of the submerged combustion melter 14. This additional equipment may be used to produce glass containers from an output of molten glass 92 that is discharged from the submerged combustion melter 14.

The segregated batch feedstock 16 is formulated to produce glass, preferably the soda-lime-silica glass described above, upon being consumed and melted within the glass melt 18 contained in the submerged combustion melter 14. In that regard, the segregated batch feedstock 16 comprises various raw materials. At a minimum, the segregated batch feedstock 16 includes the following raw materials: (i) sand (SiO₂) as a source of SiO₂ in the glass; (ii) soda ash (Na₂CO₃) as a source of Na₂O in the glass; and (iii) limestone (CaCO₃) as a source of CaO in the glass. A broad variety of other raw materials may also be included in the batch feedstock including various glass stabilizers, fluxes, network formers, network modifiers, colorants, and other materials that may be used to affect the composition and/or properties of the glass. These other materials, which are often referred to as “minors,” may include sodium sulfate, calcined alumina, aplite, nepheline syenite, dolomite, feldspar, feldspatic sand, slag, pot ash, sodium nitrate, carbon, and elemental or oxide forms of cobalt, selenium, nickel, copper, chromium, iron, manganese, arsenic, erbium, cerium, neodymium, gold, silver, and uranium. In addition to the raw materials, the batch feedstock 16 may additionally, and optionally, include cullet to reduce the necessary content of other raw materials and to help improve melting efficiency since cullet is essentially previously-formed glass that has already undergone the glass melting reactions.

The batch feedstock delivery system 12 includes a plurality of raw material containers 20 and a batch conveyor 22. The raw material containers 20 comprise at least (i) a first raw material container 20a that stores and contains sand, (ii) a second raw material container 20b that stores and contains soda ash, and (iii) a third raw material container 20c that stores and contains limestone. Each of the first, second, and third raw material containers 20a, 20b, 20c is preferably a silo that includes an upright, elongated storage reservoir 24a, 24b, 24c and a lower conical chute 26a, 26b, 26c under the storage reservoir 24a, 24b, 24c that defines a discharge outlet of the silo. Additional raw material containers (not shown) may also be included in the plurality of raw material containers 20 to store minors as well as provide storage extra capacity for any of sand, soda ash, and/or limestone if needed. The batch conveyor 22 is arranged to receive discharged sand, soda ash, and limestone from the first, second, and third raw material containers 20a, 20b, 20c, respectively, and to convey the segregated batch feedstock 16 it receives away from the raw material containers 20 in a downstream direction D. In a typical arrangement, for example, the batch conveyor 22 extends beneath each of the first, second, and third raw material containers 20a, 20b, 20c so that sand, soda ash, and limestone discharged from their respective raw material containers 20a, 20b, 20c can fall onto the batch conveyor 22 directly or via a chute, conveyor, and/or other transfer device. The batch conveyor 22 may be a standard belt conveyor of the type typically use to transfer raw materials in the glassmaking industry.

The batch feedstock delivery system 12 may also include a cullet container 28 in addition to the plurality of raw material containers 20. The cullet container 28 stores and contains cullet and is also preferably a silo that includes an upright, elongated storage reservoir 30 and a lower conical chute 32 under the storage reservoir 30 that defines a discharge outlet of the silo. If the cullet container 28 is present, the batch conveyor 22 is also arranged to receive discharged cullet from the cullet container 28 and, as before, may typically extend beneath the cullet container 28 in the same way that it may extend beneath the plurality of raw material containers 20. The cullet container 28 is preferably positioned operationally downstream of the plurality of raw material containers 20, meaning that the cullet container 28 is positioned relative to the raw materials containers 20 such that the raw materials discharged from the raw material containers 20 are deposited onto the batch conveyor 22 before the cullet is discharged onto the batch conveyor 22 from the cullet container 28. In this way, if cullet is to be included in the segregated batch feedstock 16, the cullet may be disposed over the sand, soda ash, and limestone portions of the segregated batch feedstock 16.

The batch feedstock delivery system 12 may additionally include an unloading station 34, a bucket elevator 36, and a delivery conveyor 38. The unloading station 34 includes an unloading platform 40 and a pit 42 below the unloading platform 40. The unloading platform 40 allows for trucks 44 and/or railcars 46 to dock at the unloading station 34 and unload their raw material into the pit 42. The bucket elevator 36 includes a plurality of buckets that are driven along a continuous loop between the pit 42 and the delivery conveyor 38. The buckets continuously collect raw material from the pit 42, carry the collected raw material to the delivery conveyor 38, and deposit the raw material on the delivery conveyor 38. Both the collection and deposition of the raw material may be aided by standard components at the boot and the head of the bucket elevator 36. The delivery conveyor 38 extends above the plurality of raw material containers 20 and the cullet container 28, if present, and operates to deliver the raw material to the appropriate raw material container 20. The delivery conveyor 38 may include a single conveyor or a series of conveyors that establish a conveyance path from the bucket elevator 36 to each of the raw material containers 20 and the cullet container 28. Accordingly, sand, soda ash, and limestone can be unloaded at the unloading station 34 and delivered into their assigned first, second, and third raw material containers 20a, 2b, 20c by operation of the bucket elevator 36 and the delivery conveyor 38. Similarly, cullet can be unloaded at the loading station 34, either by a truck 44 and/or railcar 46 or by transferring cullet to the pit 42 from an onsite cullet pile, and delivered to the cullet container 28 by operation of the bucket elevator 36 and the delivery conveyor 38.

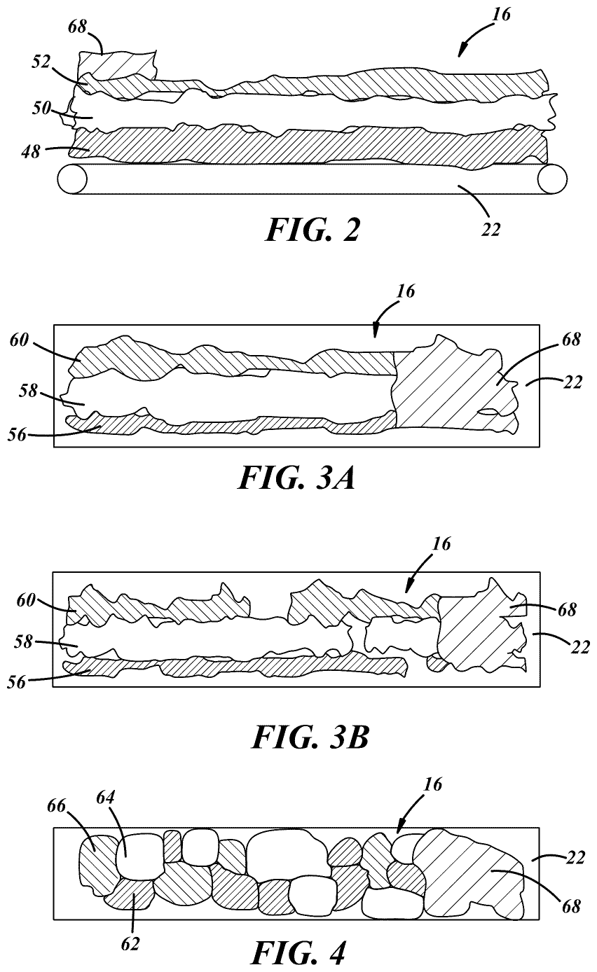

The segregated batch feedstock 16 is formed at the batch feedstock delivery system 16 by discharging, at a minimum, identifiably distinct portions of sand, soda ash, and limestone onto the batch conveyor 22. The segregated nature of the segregated batch feedstock 16 may vary. For example, as shown in FIG. 2, the segregated batch feedstock 16 may have a layered configuration in which the identifiably distinct portions of sand, soda ash, and limestone are provided as overlying layers. Specifically, in a direction upwards from the batch conveyor 22, the segregated batch feedstock 16 may include a lower raw material layer 48, an intermediate raw material layer 50 overlying the lower raw material layer 48, and an upper raw material layer 52 overlying the intermediate raw material layer 50. Each of the raw material layers 48, 50, 52 is a different one of a layer of sand, a layer of soda ash, or layer of limestone; in other words, each raw material layer 48, 50, 52 is selected from the group of a layer of sand, a layer of soda ash, and a layer of limestone, and each raw material layer 48, 50, 52 is comprised of a different raw material than the other two raw material layers 48, 50, 52. The segregated batch feedstock 16 may be formed in the layered configuration by first discharging the lower raw material layer 48 onto the batch conveyor 22, followed by discharging the intermediate raw material layer 50 onto the batch conveyor 22 over the lower intermediate layer 50, and then discharging the upper raw material layer 52 onto the batch conveyor 22 over the intermediate raw material layer 50. This can be achieved by configuring the discharge order of the plurality of raw material containers 20 relative to the batch conveyor 22 to match the order in which the layers are desired to be formed.

In the embodiment shown here in FIG. 2, the lower raw material layer 48 is a layer of sand, the intermediate raw material layer 50 is a layer of soda ash, and the upper raw material layer 52 is a layer of limestone, although the layers of soda ash and limestone could certainly be reversed. Such layering is attainable by configuring the discharge order of the plurality of raw material containers 20 to be, in sequential order, the first raw material container 20a that contains sand, the second raw material container 20b that contains soda ash, and the third raw material container 20c that contains limestone. Indeed, as the batch conveyor 22 moves in the downstream direction D, sand is discharged first onto the batch conveyor 22 out of the first raw material container 20a to establish the lower raw material layer 48 of sand. As the batch conveyor 22 continues to move forward in the downstream direction D, soda ash is discharged onto the batch conveyor 22 out of the second raw material container 20b and over the lower raw material layer 48 of sand to establish the intermediate raw material layer 50 of soda ash, and limestone is discharged onto the batch conveyor 22 out of the third raw material container 20c and over the intermediate raw material layer 50 of soda ash to establish the upper raw material layer 52 of limestone. To change what raw materials constitute the various raw material layers 48, 50, 52, the order in which the first, second, and third raw material containers 20a, 20b, 20c discharge sand, soda ash, and limestone onto the batch conveyor 22 is simply reconfigured.

In another example, as shown in FIGS. 3A-3B, the segregated batch feedstock 16 may have a striped configuration in which the identifiably distinct portions of sand, soda ash, and limestone are provided as laterally adjacent layers. Specifically, and in the downstream direction D along the batch conveyor 22, the segregated batch feedstock 16 may include a rearward raw material layer 56, a middle raw material layer 58 adjacent to the rearward raw material layer 56 on the batch conveyor 22, and a forward raw material layer 60 adjacent to the middle raw material layer 58 on the batch conveyor 22, and this pattern of side-by-side layers may be repeated within the batch feedstock 16 one or more times. The rearward, middle, and forward raw material layers 56, 58, 60 may be continuous (FIG. 3A) or discontinuous (FIG. 3B) across the batch conveyor 22 in a direction transverse to the downstream direction D and each of the raw material layers 56, 58, 60 comprises a different one of either sand, soda ash, or limestone; in other words, each raw material layer 56, 58, 60 is selected from the group of a layer of sand, a layer of soda ash, and a layer of limestone, and each raw material layer 56, 58, 60 is comprised of a different raw material than the other two raw material layers 56, 58, 60. The rearward, middle, and forward raw material layers 56, 58, 60 may be formed on the batch conveyor 22 by coordinating the timing of the discharge of sand, soda ash, and limestone from the first, second, and third raw material containers 20a, 20b, 20c, respectively, as the batch conveyor 22 moves in the downstream direction D.

In yet another example, as shown in FIG. 4, the segregated batch feedstock 16 may have a piled configuration in which the identifiably distinct portions of sand, soda ash, and limestone are provided as distinctive piles. The distinctive piles may include one or more piles of sand 62, one or more piles of soda ash 64, and one or more piles of limestone 66. The pile(s) of sand 62, the pile(s) of soda ash 64, and the pile(s) of limestone 66 may be grouped together, arranged in a repeating pattern, or arranged in a random order. Each of the pile(s) of sand, soda ash, and limestone 62, 64, 66 may be formed, for instance, by distributing the pile(s) onto the batch conveyor 22 from a feeder mechanism or a distribution mechanism that communicates with the discharge outlet of the corresponding raw material container 20. Depending on the desired arrangement of the piles of sand, soda ash, and limestone 62, 64, 66 within the piled configuration of the segregated batch feedstock 16 (i.e., grouped, random, patterned, etc.), the discharge order of the first, second, and third raw material containers 20a, 20b, 20c relative to the batch conveyor 22 may or may not be relevant.

As discussed above, the segregated batch feedstock 16 optionally includes cullet. If the segregated batch feedstock 16 includes cullet, the cullet is preferably disposed over the identifiably distinct portions of sand, soda ash, and limestone, regardless of the configuration (layered, striped, piled, etc.) of the feedstock 16, as a top layer 68 that covers the identifiably distinct portions of sand, soda ash, and limestone. The top layer 68 of cullet is itself an identifiably distinct portion of cullet and is partially shown in each of FIGS. 2-4. The top layer 68 of cullet may be formed over the identifiably distinct portions of sand, soda ash, and limestone by discharging the cullet from the cullet container 28 onto the batch conveyor 28 after each of the sand, soda ash, and limestone has been discharged by the first, second, and third raw material containers 20a, 20b, 20c, respectively, onto the batch conveyor 22. The cullet container 28 is, therefore, preferably positioned operationally downstream of the plurality of raw material containers 20 so that discharge order of the cullet is after that of the sand, soda ash, and limestone relative to the batch conveyor 22. In embodiments where the segregated batch feedstock 16 does not include cullet, the cullet container 28 may still be present to permit, if desired, the segregated batch feedstock 16 and a cullet feedstock 70 to be separately delivered to the submerged combustion melter 14, as will be described in further detail below.

The submerged combustion melter 14 receives the segregated batch feedstock 16 and melts the feedstock 16 into molten glass within the glass melt 18. The submerged combustion melter 14 includes a tank 72 and one or more submerged burners 74 received by the tank 72. The glass melt 18 is contained within a reaction chamber 76 defined by the tank 72. The submerged burners 74, which are preferably received in a floor 78 of the tank 72, are submerged by the glass melt 18 and, as such, are configured to discharge the combustion products of a combustion reaction between a fuel (e.g., methane, propane, hydrogen, etc.) and an oxidant (e.g., oxygen) directly into the glass melt 18 to both heat and agitate the melt 18. The tank 72 further defines a batch inlet 80 through which the segregated batch feedstock 16 is introduced into the reaction chamber 76, a molten glass outlet 82 from which molten glass is discharged from the reaction chamber 76 of the submerged combustion melter 14, and an exhaust outlet 84 from which an exhaust material is removed from the reaction chamber 76. The batch inlet 80 may include one or both of (i) a submerged batch inlet 80a that is submerged by the glass melt 18 and communicates directly with the glass melt 18 such that the segregated batch feedstock 16 would be introduced directly into the melt 18 and (ii) a non-submerged batch inlet 80b that communicates directly with a head space 86 of the reaction chamber 76 above the glass melt 18 such that the segregated batch feedstock would be introduced into an open space above the glass melt 18 and then fall into the glass melt 16.

The segregated batch feedstock 16 may be introduced into the submerged combustion melter 14 through the batch inlet 80 by a batch charger 88. The batch charger 88 may be appended to the tank 72 of the melter 14 and may include a feeder, such as a screw feeder, which is able to controllably introduce a measured amount of the segregated batch feedstock 16 into the reaction chamber 76. The batch charger 88 may also include a hopper to collect the segregated batch feedstock 16 from the batch conveyor 22 and feed the screw feeder with the feedstock 16, a chopper to help ensure that the molten glass inlet 80 does not become blocked, and one or more conveyors or other transport devices to move the segregated batch feedstock 16 from the batch conveyor 22 to the batch charger 88 if needed. While the identifiably distinct portions of the sand, soda ash, and limestone of the segregated batch feedstock 16 may become somewhat disturbed and begin to lose their distinctness in the batch charger 88, the batch feedstock 16 received by and introduced into the submerged combustion melter 14 is still considered “segregated” for purposes of this application because the identifiably distinct portions of the sand, soda ash, and limestone existed on the batch conveyor 22 and were not thoroughly and arbitrarily mixed before the batch feedstock 16 arrived at the batch charger 88.

The operation of the batch feedstock delivery system 12 and the submerged combustion melter 14 to produce glass may involve the steps of preparing the segregated batch feedstock 16 on the batch conveyor 22, conveying the segregated batch feedstock 16 towards the submerged combustion melter 14, introducing the segregated batch feedstock 16 into the submerged combustion melter 14, and melting the segregated batch feedstock 16 into molten glass within the submerged combustion melter 14. The step of preparing the segregated batch feedstock 16 (“preparing step”) includes storing each of sand, soda ash, and limestone in the first, second, and third raw material containers 20a, 20b, 20c, respectively, and optionally storing cullet in the cullet container 28. The preparing steps also includes discharging sand, soda ash, and limestone from their respective raw material containers 20a, 20b, 20c onto the batch conveyor 22 to produce the segregated batch feedstock 16 in a layered, striped, piled, or other configuration that includes identifiably distinct portions of sand, soda ash, and limestone, and may further include discharging cullet from the cullet container 28 to form the top layer 68 of cullet over the portions of sand, soda ash, and limestone. The step of conveying the segregated batch feedstock 16 towards the submerged combustion melter 14 includes moving the batch conveyor 22 to advance the batch feedstock 16 away from the raw material containers 20a, 20b, 20c and the cullet container 28, if present, and towards the submerged combustion melter 14.

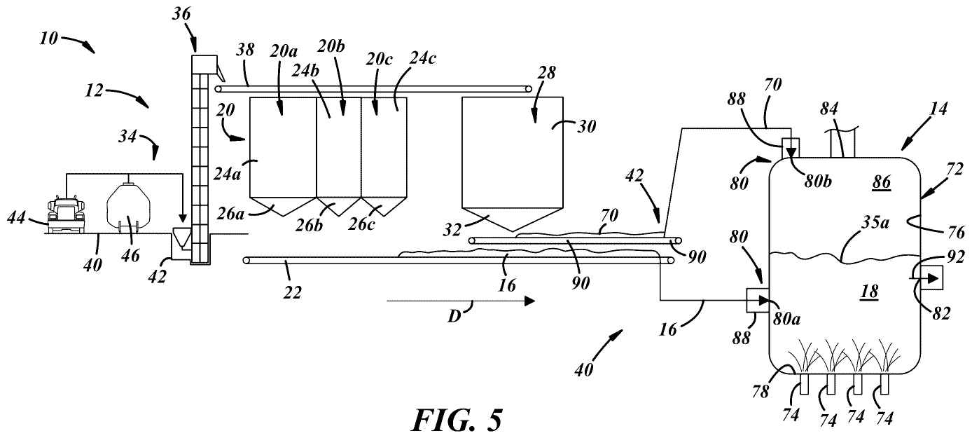

The step of introducing the segregated batch feedstock 16 into the submerged combustion melter 14 (“introducing step”) includes introducing the batch feedstock 16 into the reaction chamber 76 of the melter 14 through the batch inlet 80 so that the batch feedstock 16 is received by the glass melt 18. In the embodiment of FIG. 1 in which the segregated batch feedstock 16 includes cullet, preferably as the top layer 68 of cullet, or does not include cullet, the batch feedstock 16 may be introduced directly into the glass melt 18 through the submerged batch inlet 80a, may be introduced into the head space 86 of the reaction chamber 76 through the non-submerged batch inlet 80b and thereafter fall into the glass melt 18, or may be introduced through both the submerged and non-submerged batch inlets 80a, 80b. In an embodiment in which the segregated batch feedstock 16 does not include cullet, but cullet is nonetheless still added to the melter 14, as is illustrated in FIG. 5, the batch feedstock 16 may be introduced directly into the glass melt 18 through the submerged batch inlet 80a while the cullet feedstock 70 may be introduced into the head space 86 of the reaction chamber 76 through the non-submerged batch inlet 80b and thereafter fall into the glass melt 18. In this scenario, the segregated batch feedstock 16 is conveyed to the submerged combustion melter on the batch conveyor 22, as described above, but the cullet feedstock 70 is separately conveyed to the submerged combustion melter 14 by a cullet conveyor 90 (FIG. 5). The cullet conveyor 90, if employed, is arranged to received discharged cullet from the cullet container 28 to produce the cullet feedstock 70 and to convey the cullet feedstock 70 to the submerged combustion melter 14 separate from the batch conveyor 22 for delivery through the non-submerged batch inlet 80b.

The step of melting the segregated batch feedstock 16 into molten glass includes discharging combustion products from the one or more submerged combustion burners 74 directly into the glass melt 18 to heat and agitate the melt. This allows the segregated batch feedstock 16 that is received into the glass melt 18 to melt into molten glass that eventually becomes incorporated into the glass melt 18. An additional step of discharging molten glass from the submerged combustion melter 14 may, therefore, also be performed. The step of discharging molten glass from the submerged combustion melter 14 includes drawing molten glass from the glass melt 18 and discharging the molten glass out of the reaction chamber 76 through the molten glass outlet 82 as the output 92 of molten glass. The molten glass discharged out of the molten glass outlet 82 as the molten glass output 92 typically contains anywhere from 10 vol % to 60 vol % of gas bubbles due to the nature of submerged combustion melting. After emerging from the submerged combustion melter 14, a step of forming the output molten glass 92 into glass containers may be performed, for example, which may involve fining (bubble removal) and conditioning (thermally homogenizing and bringing to an appropriate viscosity for forming) the molten glass prior to forming the molten glass into the glass containers.

The subject matter of this application is presently disclosed in conjunction with several illustrative embodiments and modifications to those embodiments. All terms used herein are intended to be merely descriptive, rather than necessarily limiting, and are to be interpreted and construed in accordance with their ordinary and customary meaning in the art unless used in a context that requires a different interpretation. As such, many other embodiments, modifications, and equivalents thereto will readily be suggested to a person of ordinary skill in the art in view of the present disclosure and all such variations that fall within the scope of the accompanying claims, even though not necessarily explicitly disclosed, are intended to be covered by the scope of the claims and embraced by the present disclosure.

1. A method of delivering a batch feedstock to a submerged combustion melter and producing molten glass, the method comprising:
storing sand, soda ash, and limestone in a first raw material container, a second raw material container, and a third raw material container, respectively;
discharging sand, soda ash, and limestone from the first, second, and third raw material containers, respectively, onto a batch conveyor to form a segregated batch feedstock on the batch conveyor, the segregated batch feedstock comprising distinct portions of sand, soda ash, and limestone;
conveying the segregated batch feedstock downstream of the first, second, and third raw material containers and towards a submerged combustion melter; and
introducing the segregated batch feedstock into the submerged combustion melter and melting the segregated batch feedstock within the submerged combustion melter to produce molten glass.

2. The method set forth in claim 1, wherein the distinct portions of sand, soda ash, and limestone are provided as overlying layers.

3. The method set forth in claim 2, wherein the segregated batch feedstock includes a lower raw material layer, an intermediate raw material layer overlying the lower raw material layer, and an upper raw material layer overlying the intermediate raw material layer, and wherein each of the lower raw material layer, the intermediate raw material layer, and the upper raw material layer is a different one of a layer of sand, a layer of soda ash, or a layer of limestone.

4. The method set forth in claim 3, wherein the lower raw material layer is a layer of sand, and wherein the intermediate raw material layer is one of a layer of soda ash or a layer of limestone and the upper raw material layer is the other of a layer of soda ash or a layer of limestone.

5. The method set forth in claim 1, wherein the distinct portions of sand, soda ash, and limestone are provided as laterally adjacent layers on the batch conveyor.

6. The method set forth in claim 5, wherein the segregated batch feedstock includes a rearward raw material layer, a middle raw material layer adjacent to the rearward raw material layer, and a forward raw material layer adjacent to the middle raw material layer, and wherein each of the rearward raw material layer, the middle raw material layer, and the forward raw material layer is a different one of a layer of sand, a layer of soda ash, or a layer of limestone.

7. The method set forth in claim 1, wherein the distinct portions of sand, soda ash, and limestone are provided as distinctive piles.

8. The method set forth in claim 1, further comprising:
storing cullet in a cullet container; and
discharging cullet onto the batch conveyor from the cullet container such that the segregated batch feedstock also comprises cullet.

9. The method set forth in claim 8, wherein the cullet forms a top layer that covers the distinct portions of sand, soda ash, and limestone.

10. The method set forth in claim 1, wherein introducing the segregated batch feedstock into the submerged combustion melter comprises introducing the segregated batch feedstock directly into a glass melt contained within a reaction chamber of the submerged combustion melter through a submerged batch inlet.

11. The method set forth in claim 1, wherein introducing the segregated batch feedstock into the submerged combustion melter comprises introducing the segregated batch feedstock into a reaction chamber of the submerged combustion melter where a glass melt is contained through a non-submerged batch inlet that communicates with a head space of the reaction chamber above the glass melt.

12. The method set forth in claim 1, wherein the submerged combustion melter includes a tank and one or more submerged burners received by the tank, the tank defining a reaction chamber that contains a glass melt and further defining (i) a submerged batch inlet that is submerged by, and communicates directly with, the glass melt and (ii) a non-submerged batch inlet that communicates directly with a head space of the reaction chamber above the glass melt.

13. The method set forth in claim 12, wherein the segregated batch feedstock does not include cullet, and wherein introducing the segregated batch feedstock into the submerged combustion melter comprises introducing the segregated batch feedstock directly into the glass melt through the submerged batch inlet.

14. The method set forth in claim 13, further comprising:
storing cullet in a cullet container;
discharging cullet onto a cullet conveyor from the cullet container to produce a cullet feedstock; and
introducing the cullet feedstock into the submerged combustion melter through the non-submerged batch inlet.

15. A method of delivering a batch feedstock to a submerged combustion melter and producing molten glass, the method comprising:
discharging sand from a first raw material conveyor onto a batch conveyor;
discharging soda ash from a second raw material conveyor onto the batch conveyor;
discharging limestone from a third raw material conveyor onto the batch conveyor, wherein the sand, soda ash, and limestone discharged from the first, second, and third raw material containers, respectively, form a segregated batch feedstock on the batch conveyor that comprises distinct portions of sand, soda ash, and limestone;
conveying the segregated batch feedstock towards a submerged combustion melter on the batch conveyor, the submerged combustion melter including a tank and one or more submerged burners received by the tank, and wherein the tank defines a reaction chamber that contains a glass melt;
introducing the segregated batch feedstock into the submerged combustion melter and melting the segregated batch feedstock within the glass melt to produce molten glass; and
discharging a molten glass output out of the submerged combustion melter, the molten glass output comprising molten glass that includes between 10 vol % and 60 vol % of gas bubbles.

16. The method set forth in claim 15, further comprising:
discharging cullet from a cullet container onto the batch conveyor to provide a top layer of cullet that covers the distinct portions of sand, soda ash, and limestone.

17. The method set forth in claim 15, wherein introducing the segregated batch feedstock into the submerged combustion melter comprises introducing the segregated batch feedstock directly into the through a submerged batch inlet, the method further comprising:
discharging cullet from a cullet container onto a cullet conveyor to produce a cullet feedstock; and
introducing the cullet feedstock into the reaction chamber of the submerged combustion melter through a non-submerged batch inlet that communicates with a head space of the reaction chamber above the glass melt.

18. A batch feedstock delivery system comprising:
a plurality of raw material containers that includes a first raw material container that stores sand, a second raw material container that stores soda ash, and a third raw material container that stores limestone;
a batch conveyor onto which sand, soda ash, and limestone is discharged from the first, second, and third raw material conveyors to form a segregated batch feedstock;
wherein the batch feedstock delivery system does not include a batch mixer operationally between the plurality of raw material containers and the batch conveyor that receives and arbitrarily mixes the sand, soda ash, and limestone together upstream of the batch conveyor.

19. The batch feedstock delivery system set forth in claim 18, further comprising a cullet container that stores cullet and discharges cullet onto the batch conveyor.

20. A glass manufacturing system comprising:
the batch feedstock delivery system set forth in claim 18; and
a submerged combustion melter that receives the segregated batch feedstock from the batch feedstock delivery system and melts the segregated batch feedstock into molten glass.
